(19) United States
(12) Patent Application Publication
(10) Pub. No.: US 2006/0138698 A1
(43) Pub. Date: Jun. 29, 2006

(54) Method for making a tool for forming a material and tool obtainable by said method

(75) Inventor: Philippe Chapuis, Elancourt (FR)

Correspondence Address: LEVINE & MANDELBAUM, 444 MADISON AVENUE, 35TH FLOOR, NEW YORK, NY, 10022, US

(73) Assignee: Societe Financiere D'Etudes et de Developpements, Guyancourt (FR)

(21) Appl. No.: 10/522,332

(22) PCT Filed: Jul. 25, 2003
(86) PCT No.: PCT/FR03/02352

§ 371 Date: Sep. 7, 2005

(30) Foreign Application Priority Data
Jul. 26, 2002 (FR) 02/09523

(51) Int. Cl. B21D 37/16; B21D 22/20; B29C 45/73

(52) U.S. Cl. 264/255

(57) ABSTRACT

The invention concerns a method for making a material-shaping tool, in particular by hot pressing or injection moulding. The tool has an integral assembly of sections mutually adjacent along junction surfaces. Grooves provided in the junction surfaces and passages provided through the sections define a circuit for circulating a heating medium. Each section can be designed and produced, for example, by molding or machining in a block of heat-conducting material, so as to ensure an optimal configuration of the heating medium circuit.

The present invention relates to a method of producing a tool intended for the forming of a material, in particular by hot drawing or injection molding, for the purpose of making an object of defined shape therefrom, said tool having to have for this purpose a forming face of shape complementary to at least one portion of said defined shape, said method including an initial step a) that consists in designing a contour of the tool to be produced, which has a projected forming face having said complementary shape, and in devising, on the inside of said projected contour, according to said complementary shape, a projected circuit for the circulation of a heat-transfer fluid inside the tool to be produced, said projected circuit comprising a plurality of projected ducts, at least one of which constitutes a projected manifold and at least one other of which constitutes a projected branch off the projected manifold and running alongside the projected forming face.

As non-limiting examples of tools to which this method is applicable, mention may be made of the punches and dies that are used for the hot drawing of metal sheet and the components that define a molding impression in a mold for the injection molding of a thermoplastic. In both these examples, the heat-transfer fluid that is made to circulate within the tool is intended to cool the tool and, by thermal conduction through the latter, the object that is being produced, so as to harden it in the case of hot drawing and to increase its rate of solidification in the case of injection molding. In other applications, such as the thermoforming of thermoplastics, the heat-transfer fluid may also have the function of heating the object being produced, by thermal conduction through the tool, or else there may be alternate circulations of heating fluid and cooling fluid.

In the current state of the art, after the aforementioned initial step, the tool is produced by conventional casting techniques, which have certain drawbacks.

One of these drawbacks lies in the high overall production cost of a forming tool using these casting techniques. Admittedly, these techniques are generally not expensive in themselves, but their application to the production of a forming tool requires precision machining rework, which is tricky and expensive. This is because in this case the tool is generally produced in the form of two castings that fit together, one casting being comparatively thin, which defines the forming face in its entirety and has, opposite it, an array of open channels corresponding to the branches of the heat-transfer fluid circuit, and a comparatively solid casting, which serves as supporting join for the comparatively thin casting on a sole or bed of a machine, for example a hot-drawing or injection-molding machine, on the one hand, and which closes off the channels of the comparatively thin casting and contains the rest of the ducts of the heat-transfer fluid circuit, on the other. Therefore the need for the highest possible quality of the mechanical support for the comparatively thin casting on the comparatively solid casting, via mutual fitting faces of generally complex shape, and of the relatively solid casting on the sole or bed, admittedly via mutual bearing faces of generally simpler shape, and also the need to mutually isolate the channels to prevent any leakage of heat-transfer fluid from one channel to another, require the mutual fitting faces and the mutual bearing faces to be very accurately machined, in a particularly difficult manner as regards at least the mutual fitting faces because of their generally complex shape. In practice, experience shows that, even by particularly careful machining, it is difficult to prevent leakage of heat-transfer fluid between the channels, if only because expansion phenomena may result in a certain gap between the mutual fitting faces, so that it is difficult to control the circulation of heat-transfer fluid and the action of the latter on the part to be produced when the tools of the prior art are used.

Another drawback lies in the fact that the casting techniques and the raw materials that can be treated using these techniques for producing the tools do not allow these tools to be given mechanical resistance characteristics, in particular abrasion resistance characteristics, and thermal conduction characteristics as good as would be desirable, in particular in the case of hot-drawing tools.

Yet another drawback lies in the fact that technical requirements, in particular in terms of the coring of the casting molds, impose limitations on the practical realization of the circuit for circulation of the heat-transfer fluid, that is to say they do not allow the path of this circuit to be optimized according to the shape of the forming face and specific requirements as regards heat-transfer fluid circulation, i.e. in general cooling requirements, for the various regions of the forming face and of the object being produced, for example depending on the thickness that the object may have opposite these various regions, both in the case of hot drawing and in the case of injection molding, or else depending on the friction forces to which these various regions are subjected in the case of hot drawing.

The object of the present invention is to remedy these drawbacks, that is to say to allow the production of tools which, simultaneously, exhibit optimized mechanical characteristics according to the method of forming a material to which they are intended, namely in particular in terms of resistance to abrasion by the material being formed, include a circuit for circulation of a heat-transfer fluid respecting as far as possible an optimum configuration in terms of circulation requirements for the heat-transfer fluid, in particular according to the zones of the forming face, and exhibit thermal conductivity characteristics that are as good as possible, in particular between this heat-transfer fluid circuit and the forming face.

For this purpose, the present invention proposes a method of the type indicated in the preamble, which method is characterized:
in that the initial step a) is implemented by placing at least a projected first duct over as simple as possible an average surface, the average surface of the or each projected first duct intersecting the projected forming face, thereby defining sections of the projected forming face, and of at least one projected second duct, thereby defining sections of the or each projected second duct; and
in that the method then comprises the succession of steps consisting in:

b: producing tool slices, each of which is bounded in particular by at least one mating face, at least certain mating faces at least approximately reproducing a respective average surface, namely, acrosswise, by two mating faces at least approximately reproducing, respectively, each of the two respective average surfaces, and by at least the blank for a useful face reproducing a respective projected forming face section adjacent said respective average surface, namely, in a spanning manner, a projected forming face section bounded by said respective two average surfaces, and includes, on the one hand, within its thickness, a passage reproducing the respective section of the or each projected second duct and emerging in the or each mating face and, on the other hand, in the or each mating face, a groove connected as a branch off said passage and at least approximately reproducing one half of the respective projected first duct,

c: juxtaposing the tool slices via their mating faces and mutually fastening them in a relative position in which the useful faces or said blanks, the passages and the grooves are complementary from one slice to the other slice in order to constitute, respectively, the forming face or a forming face blank, the or each second duct and the or each first duct, and, where appropriate, machining the forming face blank in order to produce the forming face.

Insofar as the tool thus obtained has a structure characteristic per se, the present invention extends to a tool that can be produced by the method according to the invention and intended for the forming of a material, in particular by hot drawing or injection molding, for the purpose of making an object of defined shape therefrom, said tool having for this purpose a forming face of shape complementary to at least one portion of said defined shape, and an internal circuit for the circulation of a heat-transfer fluid, said circuit comprising a plurality of ducts, at least one of which constitutes a manifold and at least one other of which constitutes a branch off the manifold and running alongside the forming face, characterized in that it consists of a bonded assembly of tool slices mutually juxtaposed by mating faces, at least certain of which coincide at least approximately with as simple as possible an average surface, of a first duct, and which intersect the forming face, thereby defining forming face sections, and of at least one second duct, thereby defining second duct portions.

A person skilled in the art will readily understand that it is admittedly possible to produce at least one, or even each, of the tool slices by casting, during step b), starting from raw materials that lend themselves thereto if the latter make it possible in particular to obtain the desired mechanical and thermal characteristics of this or these tool slices, but that it is also possible to produce the tool slices, during step b), by machining in a preexisting block of a thermally conductive raw material, and in particular in such a raw material that does not lend itself to the production of castings, so that the method according to the invention considerably extends the choice of raw materials that can be used for producing a forming tool, for example a hot-drawing or injection-molding tool.

In particular, the raw material for the tool may thus be chosen from a group comprising Al₂O₃-copper alloys, cadmium copper alloys, beryllium copper alloys and stainless steels, which, in the current state of the art, do not lend themselves, or lend themselves poorly, to the production of tools by casting, and are much more advantageous than materials that lend themselves to casting, both in terms of thermal conductivity and in terms of mechanical resistance, in particular abrasion resistance.

Furthermore, whether a tool slice is produced by casting or by machining from a preexisting block of thermally conductive raw material, the provision of a section of second duct in each of the slices and of a first duct at least approximately per half in each mating face between slices and the possibility of shaping each of the slices at will, in particular as regards their mating faces, allow the positions of the average surfaces of the first ducts relative to one another and relative to the forming face to be freely chosen, and consequently allow the path of the heat-transfer fluid circulation circuit to be optimized according to requirements connected with the shape of the forming face and with the action that the latter exerts on the material of the object being produced, and according to the possibly different thickness that the latter has opposite the various regions of the forming face.

Implementation of the method according to the invention thus makes it possible to optimize the working conditions of the tool and consequently the quality of the object obtained by means of this tool.

In addition, whether a tool slice is produced by casting and then subjected to a localized finish machining operation or whether it is entirely produced by machining from a preexisting block of a thermally conductive raw material, the machining operations may be carried out much more simply and much less expensively than when machining operations have to be carried out on those parts of a tool that are produced by casting in accordance with the prior art, since the implementation of the invention, by making it possible to machine slice by slice, generally makes it possible to limit the machining to simple surfaces, in particular to those formed by the mating faces, between which it is also easier to maintain sealing even during thermal expansion of the tool, and to drilling and/or milling operations carried out on these simple surfaces.

Thus, although it is in principle possible to give any desired conformation to the average surfaces of the elementary ducts, that is to say to the mating faces that at least approximately coincide with these average surfaces, it is preferred as far as possible to implement said initial step a) of the method according to the invention by giving said average surfaces and said mating faces an at least approximately plane shape, in which case they are preferably oriented, respectively, so as to be at least approximately parallel to one another if a plurality thereof is provided.

Moreover, the operation of assembling the various tool slices is simplified since this assembly may in this case be carried out by means that act on the outermost slices along a direction perpendicular to the various mating faces and clamping the intermediate slices between these outermost slices; among the means that can be used for this purpose, mention may be made of hoops and ties, these examples in no way being limiting. However, other methods of assembling the tool slices may be chosen, in particular methods of assembly such as brazing, allowing the relative orientation of the average surfaces and of the mating faces to be freely chosen, i.e. which do not impose any constraint in this regard, and providing, without any additional arrangement, sealing between slices, that is to say sealing of the heat-transfer fluid circuit, although it may be necessary to provide this sealing by specific means, such as added gaskets when the mutual fastening of the slices is provided by mutual clamping.

The first studies have shown that such at least approximate planarity and at least approximate mutual parallelism of the average surfaces of the first ducts will make it possible in most cases for the requirements in terms of heat-transfer fluid circulation to be satisfied in an optimum manner in relation to the shape of the forming face and to the requirements in terms of heat exchange between the heat-transfer fluid and the object being formed, while at the same time simplifying the production of the tool slices and their assembly into the state in which they are mutually juxtaposed via the mating faces.

The method according to the invention also makes it possible to form the or each second duct in a particularly simple manner according to the requirements, while still simplifying the compliance with an optimum configuration, defined during the initial step a). This is because, to a good approximation, it is acceptable to give each section of projected second duct, that is to say to each passage, a straight or V shape, defined by two angularly offset straight arms, which is particularly easy to produce both by machining in the corresponding tool slice and by casting, it being understood that machining or coring in casting makes it possible to comply with possible changes of section and/or of orientation of the or each second duct, both between two slices and within one slice, on the one hand, and that the mutual join between slightly angularly offset straight sections or passages or of straight arms thus slightly angularly offset, in order to comply with a desired path of the or each second duct, does not generally have any drawback in terms of circulation of the heat-transfer fluid.

In this regard, it would not be outside the scope of the present invention to provide an additional subdivision of a projected tool into slices having mating faces without a groove, that is to say that do not define a first duct when they are assembled via these mating faces. Such an additional subdivision may for example be chosen in order to make it easier to produce projected second ducts having changes of section and/or a non-straight path, since this subdivision makes it possible to produce these projected second ducts by the abutment of straight or V-shaped passages, of possibly different cross section, provided in respective tool sections, in a particularly simple manner both by machining and by casting.

The most appropriate choice between the or each manifold and the or each branch as regards the first duct, made approximately per half in the mating faces of two adjacent tool slices, or as second duct, produced in the form of passages made in the thickness of the tool slices, falls within the normal competence of a person skilled in the art and may vary according to the shape of the object to be produced, namely more precisely the shape of the projected forming face, depending on this shape of the object.

Thus, when, in the case of an object having the shape of a beam or a similar shape, elongate in a defined longitudinal direction, the initial step a) is implemented by giving the projected forming face a shape elongate along a defined longitudinal direction, the initial step a) is also implemented by orienting the or each projected manifold at least approximately longitudinally and by orienting the or each projected branch and the or each average surface at least approximately transversely and by choosing, as projected first duct, the or each projected branch and, as projected second duct, the or each manifold, and step b) is implemented by orienting the or each mating face and the or each groove at least approximately transversely and by orienting the or each passage at least approximately longitudinally. Therefore, the tool according to the invention is thus characterized in that the forming face has a shape elongate along a defined longitudinal direction, the or each mating face and the or each average surface are at least approximately transverse, the or each first duct is at least approximately transverse and constitutes a branch, and the or each second duct is at least approximately longitudinal and constitutes a manifold. In such a case, the or each manifold usually has a linear general shape, which is more or less straight, and two examples of this are generally provided, one of which is used for the inflow of the heat-transfer fluid and the other for its return, and between which the or each branch forms a loop locally running alongside the forming face.

However, when in the case of an object having the shape of a pot or a similar shape, going around a defined longitudinal axis, the initial step a) is implemented by giving the projected forming face a shape going around a defined longitudinal axis, the initial step a) is also implemented by orienting the or each projected branch at least approximately longitudinally and orienting the or each projected manifold and the or each average surface at least approximately transversely, and by choosing, as projected first duct, the or each manifold and, as projected second duct, the or each projected branch, and step b) is implemented by orienting the or each mating face and the or each groove at least approximately transversely and by orienting the or each passage at least approximately longitudinally. The tool according to the invention is therefore characterized in that the forming face has a shape going around a defined longitudinal axis, the or each mating face and the or each average surface are at least approximately transverse, the or each first duct is at least approximately transverse and constitutes a manifold, and the or each second duct is at least approximately longitudinal and constitutes a branch. In such a case, the or each manifold usually has an annular general shape and two examples of this are generally provided, one of which is used for the inflow of the heat-transfer fluid and the other for its return, and between which the or each branch has a linear general shape, which is more or less straight.

These two examples correspond to frequent application cases, but they are in no way limiting.

Other features and advantages will become apparent from the description below, relating to two non-limiting examples of methods of implementing the invention, and also from the appended drawings which accompany this description.

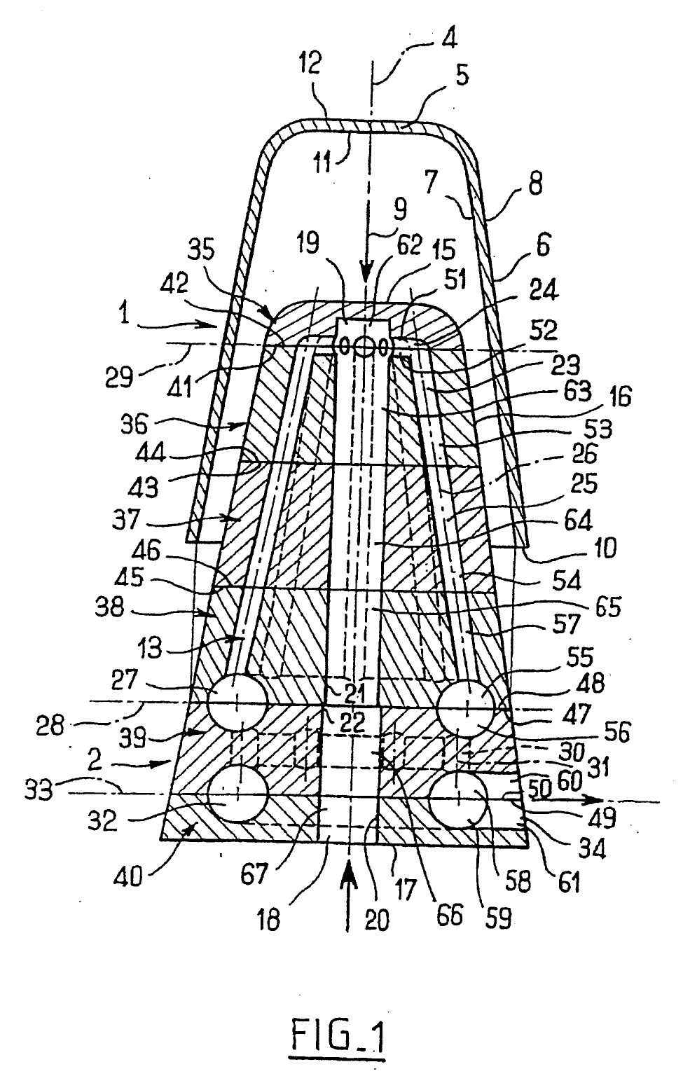

FIG. 1 shows a view of a punch intended for the production of a part in the form of an axisymmetric pot by the hot drawing of a metal sheet, and also a view of the part thus produced, during extraction of the punch, in cross section in a plane passing through an axis common to the punch and to the part.

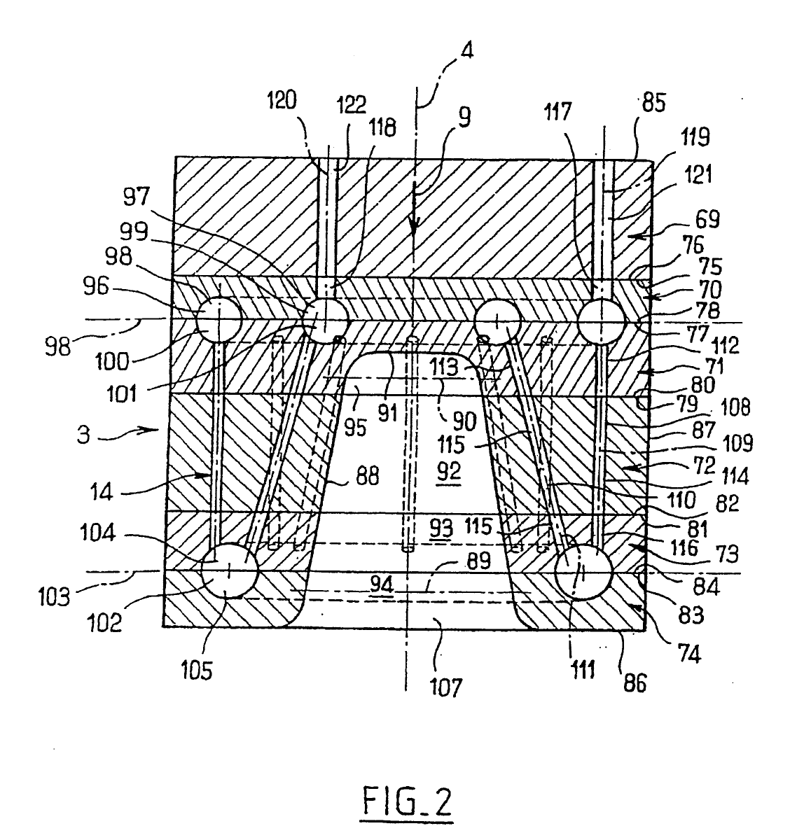

FIG. 2 shows, in a sectional view similar to that of FIG. 1, the corresponding die.

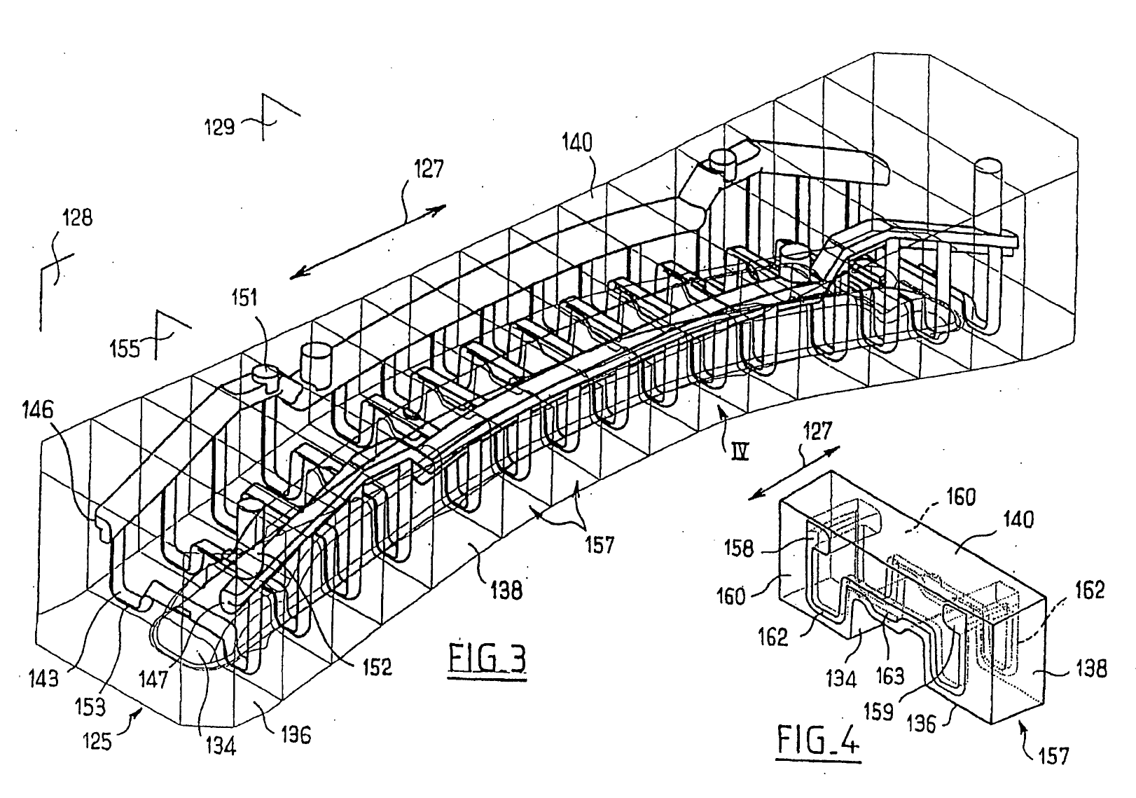

FIG. 3 shows a perspective view of the outline of a die according to the invention, intended for the production of a hollow, elongate beam such as a bumper crossmember for motor vehicles, by the hot drawing of a metal sheet, with illustration of the outline of the various slices of this die and illustration of the heat-transfer fluid circuit within said die.

FIG. 4 shows a perspective view, similar to that of FIG. 3, of one of the slices of this die, identified as IV in FIG. 3; and

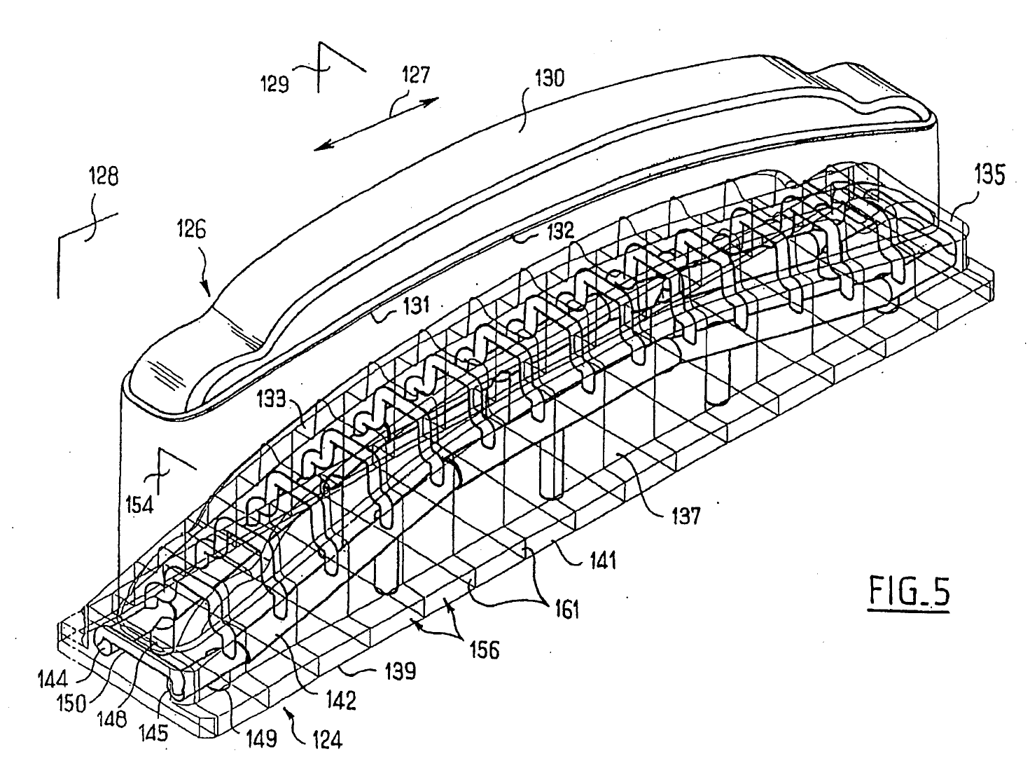

FIG. 5 shows, in a view similar to that of FIG. 3, the corresponding punch and also illustrates the part produced by hot drawing by means of the die of FIG. 3 and of the punch of FIG. 5, as it is during extraction of the punch.

Although the tools according to the invention that have been illustrated in FIGS. 1 and 2 and in FIGS. 3 to 5, respectively, correspond to two cases in which a tool according to the invention is applied to the production of a part by the hot drawing of a metal sheet, a person skilled in the art will readily understand that it would be possible to produce, in an entirely similar manner, tools intended for the production of a part with the same respective shape by the injection molding of a thermoplastic. The modifications to be made for this purpose to the tools that have been illustrated and that will be described fall within the normal competence of a person skilled in the art, one essential difference residing in the fact that the tools intended for injection molding, corresponding to the punch and to the die respectively, must between them define a closed impression for receiving the thermoplastic, whereas this condition does not have to be fulfilled between a hot drawing punch and a die.

Reference will firstly be made to FIGS. 1 and 2, in which the part to be produced, or that has been produced, is denoted by 1 and the punch and the die used for this purpose are denoted by 2 and 3 respectively. A longitudinal axis of the pot-shaped part 1 is denoted by 4, said part being, in this example, a body of revolution about this axis 4, and the same reference denotes a respective axis of symmetry of revolution of the punch 2 and of the die 3. A person skilled in the art will readily understand that the arrangements that have been described in respect of the punch 2 and the die 3, in relation to an axisymmetric part 1, could be adapted without any difficulty to the case of a punch 2 and a die 3 that are intended for the production of a part 1 which, while having the general shape of a pot going around a longitudinal axis 4, are bodies of revolution about this axis 4 having a different shape, while still having a shape compatible with production by hot drawing; the same would apply if the tools formed by the punch 2 and the die 3 in this example were intended for the production of the object 1 by the injection molding of a thermoplastic. The shape of the object 1 and the correlated shape of the punch 2 and of the die 3 that will be described must therefore be considered as a simple illustration of the invention, with no limiting character as regards the invention.

In the example illustrated, the object 1 has, made as a single sheet metal part, a flat, transverse bottom 5 intersecting the axis 4, and an annular, longitudinal side 6 going around the axis 4, bordering the bottom 5 and flaring outward from a curvilinear join to said bottom.

More precisely, the side 6 is bounded in this example, respectively toward the axis 4 and in the direction of going away from the latter, by an inner peripheral face 7 and by an outer peripheral face 8 which are frustoconical, axisymmetric about the axis 4, mutually parallel and flaring outward in a longitudinal direction 9 as far as a transverse, annular free edge 10 which is axisymmetric about the axis 4, is at least approximately plane and perpendicular to this axis 4. In the opposite direction to the direction 9, the faces 7 and 8 of the side 6 are joined respectively to a plane inner face 11 of the bottom 5, via a concave curvature, and to a plane outer face 12 of this bottom 5, via a convex curvature, the two faces 11 and 12 being mutually parallel and perpendicular to the axis 4 that they intersect.

The punch 2 is intended for forming the inner faces 7 and 11, while the die 3 is intended to form the outer faces 8 and 12, starting from a flat blank (not shown) cut from a steel sheet and heated to an appropriate temperature, as is known in general in the field of hot drawing. The punch 2 and the die 3 are also intended to ensure, as is also known in this field, that the object 1 produced is quenched by accelerated cooling by means of a circulation of a cooling fluid inside the punch 2 and inside the die 3, each of which includes, on the inside, for this purpose a circuit 13, 14 for circulation of this fluid. As cooling fluid, it is possible to use water for example, but other fluids could be used, the nature of the heat-transfer fluid circulating in a tool according to the present invention not being critical as regards the latter.

In relation to the shape of the inner faces 7 and 11 that it must form, the punch 2 has, in the example illustrated, a frustoconical general shape axisymmetric about the axis 4, this shape being defined by:
a transverse face 15 facing the opposite way to the direction 9 and complementary to the inner face 11 of the bottom 5, that is to say a transverse plane face cutting the axis 4 at right angles;
an outer peripheral face 16 complementary to the inner peripheral face 7 of the side 6, that is to say a frustoconical face axisymmetric about the axis 4 with a conicity identical to that of the face 7, this outer peripheral face 16 thus flaring outward in the direction 9 from its curvilinear join to the transverse face 15, which join is convex and complementary to the concave curvilinear join between the face 7 and the face 11, the outer peripheral face 16 having, however, greater longitudinal dimensions than those of the inner peripheral face 7; and
another plane transverse face 17, perpendicular to the axis 4 and facing the direction 9, the outer peripheral face 16 joining this transverse face 17 longitudinally on the opposite side from its join to the transverse face 15.

Thus, only a portion of the peripheral face 16, namely its portion longitudinally closest to the transverse face 15, serves for forming the inner peripheral face 7 of the side 6 of the object 1, whereas, during this forming, a portion of this face 16, adjacent to the face 17, remains separate from the object 1.

Since the outline of the punch 2, as regards the respective shapes and the relative arrangement of the transverse face 15 and of the peripheral face 16, is determined according to the internal shape of the object 1 produced, as defined by the inner faces 7 and 11 thereof, the circuit 13, during the design of the punch 2, is exclusively or practically exclusively designed according to the desired effect of cooling the object 1 being produced, by thermal conduction through the constituent material of the punch 2 from this circuit 13.

In the example illustrated, the circuit 13 includes a heat-transfer fluid inlet manifold or duct 18, placed longitudinally and more precisely axially, which has the shape of a blind hole emerging in the transverse face 17 and closed off in the immediate vicinity of the transverse face 15 by a transverse plane end wall 19. This manifold 18 is bounded, in the direction going away from the axis 4, by a first cylindrical inner peripheral face section 20 axisymmetric about the axis 4 with a defined diameter (not referenced) in its region closest to the transverse face 17, and by a likewise cylindrical inner peripheral face section 21 axisymmetric about the axis 4 but with a slightly smaller diameter than that of the section 20 in its region closest to the end wall 19, the two sections 20 and 21 being joined together via a plane, annular shoulder 22 axisymmetric about the axis 4 and facing along the direction 9, at a longitudinal distance from the face 15 that corresponds approximately to the longitudinal distance that mutually separates the free edge 10 of the side 6 and the inner face 11 of the bottom 5 of the object 1 to be produced. In this regard, the longitudinal dimension of the section 21 is substantially greater than that of the section 20.

In the immediate vicinity of the end wall 19, the manifold 18 branches out into eight branch ducts 23, each of which lies in a respective mid-half-plane defined by the axis 4, which branch ducts thus radiate, radially with respect to this axis 4, from a respective mouth in the inner peripheral face section 21 of the inlet manifold 18.

Each of the branch ducts 23 has, in succession, starting from this mouth in the inlet manifold 18:
a first straight portion 24 oriented radially with respect to the axis 4, that is to say in particular having a mid-plane 29 perpendicular to this axis 4, and common to all the portions 24; and
from an end of the portion 24, which is furthest away from the axis 4 while still remaining set back toward the latter relative to the outer peripheral face 26 of the punch 2, a respective straight portion 25, moving away from its join to the portion 24 along a respective axis 26 that progressively moves away from the axis 4 in the direction 9, making, with respect to the axis 4, an angle (not indicated) approximately identical to that which the outer peripheral face of the punch 2 makes with respect to this axis, in such a way that each of the portions 25 runs alongside and parallel to this inner peripheral face 16 inside the punch 2, and likewise each portion 24 runs alongside and parallel to the transverse face 15 of the tool 2 inside the latter.

Each of the portions 24 and 25 has a circular cross section of the same diameter over its length.

On the opposite side from its join to the respective portion 24, each portion 25 is joined to an intermediate manifold 27, also made inside the punch 2 and having an annular shape axisymmetric about the axis 4, and more precisely a toroidal shape in the example illustrated, with a circular cross section of larger diameter than that of the portions 24 and 25 and substantially identical to that of the section 20 of the inner peripheral face of the inlet manifold 18, that is to say slightly greater than that of the section 21 of the inner peripheral face of the latter or even substantially greater than that of the portions 24 and 25.

The intermediate manifold 27 lies in a transverse mid-plane 28 in which the shoulder 22 joining together the sections 20 and 21 of the inner peripheral face of the manifold 18 also lies.

The intermediate manifold 27 runs alongside the outer peripheral face 16 of the punch 2 in the same way as the portion 25 of each branch duct 23.

This intermediate manifold 27 is itself connected, via eight cylindrical longitudinal ducts 30 axisymmetric about respective longitudinal axes 31 parallel to the axis 4 and lying in half-planes defined by this axis 4 and uniformly distributed angularly about the latter, to an outlet or return manifold 32 which has substantially the same shape as this intermediate manifold 27 but is shifted in the direction 9 relative to the latter, that is to say it lies between this intermediate manifold 27 and the transverse face 17 of the punch 2.

Preferably, the ducts 30 alternate, circumferentially around the axis 4, with the portions 25 of the branched ducts 23 in order to ensure optimum distribution of the heat-transfer fluid inside the intermediate manifold 27, followed by an optimum passage toward the outlet manifold 32.

The outlet manifold 32 lies in a transverse plane 33, which is therefore shifted toward the transverse face 17 of the punch 2 relative to the transverse mid-plane 28 of the manifold 27. Lying in this same plane 33 is a duct 34 oriented radially relative to the axis 4 and joining the outlet manifold 32, in the direction going away from the axis 4, to an outlet mouth for the heat-transfer fluid, located in the outer peripheral face 26 of the tool 2 but on the outside of that region of this outer peripheral face 26 which serves for forming the inner peripheral face 7 of the side 6 of the object 1.

In accordance with the present invention, once the circuit 13 has been designed according to the thermal requirements at the outer faces 15 and 16 of the punch 2, especially as regards the branch ducts 23, after the geometry of the faces 15 and 16 of the punch 2 have been designed according to the shape to be given to the inner faces 11 and 7 of the object 1, respectively, a subdivision of the punch 2 to be produced into a plurality of slices is projected, these slices being, in the example illustrated, six in number, referenced 35, 36, 37, 38, 39 and 40 respectively, oriented transversely relative to the axis 4 and coming one after the other, in this order, longitudinally in the direction 9.

The slice 35, or slice furthermost upstream relative to the direction 9, is bounded, on one side, by the transverse face 15 and the rounded join between the latter and the outer peripheral face 16 of the punch 2 and, on the other side, by a plane face 41 perpendicular to the axis 4, shifted in the direction 9 relative to the transverse face 15 and more precisely lying in the mid-plane 29, this face 41 constituting a mating face of the slice 35, which mates with the slice 36 coming next in the direction 9.

When the punch 2 has been produced, this mating face 41 bears flat on a likewise plane mating face 42, perpendicular to the axis 4 and lying in the plane 29, which mating face 42 delimits the slice 36 in the opposite direction to the direction 9. In this direction 9, the slice 36 is bounded by a plane face 43 perpendicular to the axis 4 and constituting a mating face, which mates with the slice 37 coming next in the direction 9. For this purpose, the slice 37 is itself bounded in the opposite direction to direction 9 by a mating face 44, which mates with the slice 36, which face 44 is plane, perpendicular to the axis 4, and is applied flat against the face 43 when the tool 2 has been produced.

In the direction 9, the slice 37 is bounded by a plane face 45 perpendicular to the axis 4 and mating with the slice 38 coming next in the direction 9, which slice is bounded in the opposite direction to the direction 9 by a face 46 that is also plane and perpendicular to the axis 4, which is applied flat against the face 45 and thus constitutes a mating face of the slice 38, which mates with the slice 37.

In the direction 9, the slice 38 is bounded by a plane face 47 perpendicular to the axis 4 and lying in the mid-plane 28 of the manifold 27. This face 47 serves as a mating face with the slice 39 coming next in the direction 9, which slice is bounded in the opposite direction to the direction 9 by a plane face 48, perpendicular to the plane 4 and lying in the plane 28, this face 48 mating with the slice 38 being applied flat against the face 47 when the punch 2 has been produced. In the direction 9, the slice 39 is bounded by a plane face 49 perpendicular to the axis 4 and lying in the plane 33, which face 49 constitutes a face for mating with the slice 40 that comes next in the direction 9, which slice is bounded in the opposite direction to the direction 9 by a face 50 for mating with the slice 49, which face 50 is also plane, perpendicular to the axis 4 and lying in the mid-plane 33 of the manifold 32 in order to be applied flat against the face 49 when the punch 2 has been produced. In the direction 9, the slice 40, which constitutes the slice furthermost downstream in the direction 9, is bounded by the face 17.

In the direction moving away from the axis 4, each of the slices 35, 36, 37, 38, 39 and 40 is bounded by a respective annular section of the outer peripheral face 16 of the punch 2 which is to be produced or has been produced, these sections of the peripheral face 16 being joined together to define said peripheral face when the punch 2 has been produced.

Since the mating faces 41 and 42 between the slices 35 and 36 coincide with the plane 29 that constitutes the mid-plane of symmetry of the portions 24 of the various branch ducts 23, each of these portions 24 is produced, per half, in each of these mating faces 41 and 42 by making a respective groove 51, 52 of semi-circular cross section. When the slices 35 and 36, which have been produced separately, are assembled by mutually applying, flat, the mating faces 41 and 42, the grooves 51 and 52 are mutually complementary in order to form the respective portions 24.

Also made in the slice 36, along the axes 26, are straight passages 53 which thus pass right through the slice 36, longitudinally, that is to say from the mating face 42 to the mating face 43, and constitute a respective section of a portion 25 of each branch duct 23.

Likewise, passing longitudinally right through the slice 37, along each of the axes 26, is a respective straight passage 54 that emerges in the mating faces 44 and 45 and corresponds to a section of a portion 25 of a respective branch duct 23. It may be seen that no groove similar to the grooves 51 and 52 is provided in the mating faces 43, 44 and 45, and the same applies in the mating face 46 of the slice 38.

In contrast, provided in the mating face 47 of the slice 38 that mates with the slice 39, and likewise in the mating face 48 of the slice 39 that mates with the slice 38, these faces 47 and 48 coinciding with the mid-plane 28 of the manifold 27, is a respective annular groove 55, 56 having a respective semicircular cross section and corresponding to a respective half of the intermediate manifold 27, as subdivided by its mid-plane 28.

Also provided in the slice 38, along each axis 26, is a respective straight longitudinal passage 57 that emerges, on one side, in the mating face 46 that mates with the slice 37 and, on the other side, in the groove 55 in order to constitute a respective portion of a section 25 of the respective branch duct 23.

Likewise, provided in each of the mating faces 49 and 50, which coincide with the mid-plane 33 of the outlet manifold 32, are, on one side, a respective annular groove 58, 59 of semicircular cross section, corresponding to one half of this outlet manifold 32 as subdivided by its mid-plane 33, and, on the other side, a straight groove 60, 61 that is radial relative to the axis 2 and corresponds to a respective half of the outlet 34 as subdivided by the mid-plane 33.

When the various slices have been assembled, the grooves 55 and 56 are mutually complementary in order to form the intermediate manifold 27, the grooves 58 and 59 are mutually complementary to form the outlet manifold 32 and the grooves 60 and 61 are mutually complementary to form the outlet 34.

Furthermore, two longitudinal passages are provided in the slice 39, along the axis 31, each of which entirely constitutes a respective duct 30 and mutually joins the grooves 56 and 58 provided respectively in the mating faces 48 and 49 of this slice 39.

Moreover, each of the slices 35 to 40 defines, by a respective axial longitudinal passage 62, 63, 64, 65, 66, 67, a respective section of the inlet manifold 18. In this regard, the passage 62 is blind, hollowed out in the linking face 41 of the slice 35 and it is bounded, on one side, in the opposite direction to the direction 9, by the end wall 19, placed set back relative to the mating face 41 in the direction opposite to the direction 9, and, on the other side, in the direction moving away from the axis 4, by a corresponding portion of the inner peripheral face section 21 of the manifold 18. The sections 63, 64, 65 pass right through the slices 36, 37, 38 respectively and correspond to a respective portion of the inner peripheral face section 25 of the inlet manifold 18. The passages 66 and 67 themselves pass right through the slice 39 and the slice 40 respectively and correspond to a respective portion of the section 20 of the inner peripheral face of the inlet manifold 18; in other words, they have, relative to the axis 4, a larger diameter than that of the passages 62, 63, 64, 65, the shoulder 22 being defined by a marginal region of the mating face 47 of the slice 38, around the mouth of the passage 65 in that face.

Once the punch 2, intellectually subdivided into the various slices 35 to 40, with the respective grooves and passages corresponding to sections of the projected circuit 13, has been designed, these slices 35 to 40 are produced independently of one another, either by casting together with the respectively corresponding grooves and/or passages, or by machining a respective preexisting block of a thermally conductive material, preferably chosen from the aforementioned materials when it is a hot-drawing punch 2 that has to be produced; in this regard, it will be advantageous to use Al₂O₃-copper alloys sold under the registered trademark GLIDCOP, under the references A115, A125 and A160, by OMG Americas, which have high values in terms of 2% yield strength in MPa and in terms of thermal conductivity, or else cadmium copper alloys that also have good characteristics in this regard, these materials being indicated, however, merely by way of non-limiting example.

Once the slices 35 to 40 have thus been produced, either by casting or by machining, they are mutually assembled by mutual application, flat, of their mating faces 41 to 49, thereby forming the punch 2. This assembly may be carried out by various means, as was indicated above, but it should be pointed out that the aforementioned materials lend themselves well to brazing, which makes it possible to ensure at the same time sealing of the circuit 13.

When the faces 15 and 16 intended for forming the object 1 have a simple conformation, as illustrated, each of the slices 69, 70, 71, 72 and 73 may be produced in such a way that it has its final conformation at a respective useful face intended to constitute the face 15 or a respective portion of the face 16; the faces 15 and 16 of the tool 1 are then obtained directly by mutually assembling the slices. However, when the faces intended for the forming operation have a relatively complex shape, it may be preferable to produce, on each slice, only the blank for a useful face, in which case what is obtained upon assembly is merely a forming face blank and the assembly of the slices is followed by this blank being machined in order to produce the forming face.

The die 3 is designed using a similar intellectual approach, characteristic of the present invention, and is composed, in the example illustrated, of six slices 69 to 74 which come one after another longitudinally in the direction 9 of the axis 4 and are mutually bonded together in the mutually contiguous state via plane mutual mating faces 73 to 84 that are perpendicular to the axis 4 and face alternately in the direction 9, as regards the faces 75, 77, 79, 81 and 83, defining in this direction the slices 69, 70, 71, 72 and 73 respectively, and in the opposite direction to the direction 9 as regards the faces 76, 78, 82 and 84, which define the slices 70, 71, 72, 73 and 74, respectively, in the opposite direction to the direction 9. The slice 69, in the opposite direction to 9, and the slice 74, in the direction 9, are furthermore bounded by a free plane face 85, 86 respectively, perpendicular to the axis 4 and facing the opposite direction to the direction 9 and in this direction 9, respectively, these faces 85 and 86 constituting outer peripheral faces of the die 3.

Moreover, in the direction going away from the axis 4, the die 3 is bounded by an outer peripheral face 87, which is for example cylindrical and axisymmetric about the axis 4, and each slice 69 to 74 of which forms a portion via a respective outer peripheral face (not indicated). However, this shape of the face 87 is of no consequence as regards the forming of the object

The die 3 defines, around the axis 4 and toward the latter, a hot-drawing cavity 107 for the object 1 to be produced, which cavity 107 is longitudinal and opens into the face 86 in the direction 9, whereas it is closed toward the face 85 in the opposite direction.

More precisely, the cavity 107 is bounded, in the direction away from the axis 4, by a frustoconical inner peripheral face 88 axisymmetric about the axis 4, which flares out in the direction 9 with a conicity identical to that of the outer peripheral face 8 of the side 6 of the object 1 to be produced, between two geometric planes 89 and 90 that are perpendicular to the axis 4 and pass respectively on the inside of the slice 74 between the faces 84 and 86 of the latter, and on the inside of the slice 71, between the faces 78 and 79 of the latter and respectively closer to the face 84 than to the face 86 and closer to the face 79 than to the face 78. Between the plane 89 and the face 86, the inner peripheral face 88 of the cavity 107 flares out even more, along a curvilinear profile, in order to make it easier for the metal sheet to engage into the cavity 107 during drawing. Longitudinally on the opposite side from the point where it joins the face 86, in the opposite direction to the direction 9, the inner peripheral face is joined, in the plane 90, to a plane inner face 91 perpendicular to the axis 4 and complementary to the outer face 12 of the bottom 5 of the object 1 to be produced, the join being curvilinear and complementary to the mutual join between the outer peripheral face 8 of the side 6 of the object 1 to be produced and the outer face 12 of the bottom 5 of said object 1.

The end face 91 of the cavity 107, its curvilinear join to the face 88, and a section of the latter are hollowed out in the face 79 of the slice 71 and the rest of the face 91 is distributed in sections between the slices 72, 73, 74 which, for this purpose, are pierced right through, axially, by a respective passage 92, 93, 94, whereas the slice 71 is pierced by a blind axial hole 95 in its face 79 in order to constitute the end face 91, the corresponding portion of the outer peripheral face 88 and their curvilinear mutual join.

The circuit 14 for circulation of a heat-transfer fluid, namely a cooling fluid such as water in this example, is made essentially in the slices 71, 72, 73, 74 around the cavity 107 and comprises two annular transverse manifolds 96, 97 axisymmetric about the axis 4 and having the same circular cross section, which lie coaxially in the same transverse mid-plane 98 in which the mating faces 77 and 78 between the slices 70 and 71 lie. These manifolds 96 and 97, for the inlet and outlet of the heat-transfer fluid respectively, are placed in the immediate vicinity of the outer peripheral face 87 of the die 3 and in the immediate vicinity of a geometrical extension of the inner peripheral face 88 of the cavity 107, respectively, and each of them is defined in respect of one half by a respective annular groove 98, 99 made in the mating face 77 of the slice 70 and in respect of the other half by a respective annular groove 100, 101 made in the mating face 78 of the slice 71, the two halves of each manifold 96, 97 being defined by the mid-plane 98.

Likewise, an annular transverse intermediate manifold 102 axisymmetric about the axis 4 and of circular cross section, which in this case is slightly greater than that of the manifolds 96 and 97, is provided in a mid-plane 103 perpendicular to the axis 4, the mating faces 83 to 84 of the slices 73 and 74, between the inner peripheral face 88 of the cavity 107 and the outer peripheral face 87 of the die 3, near the mouth of the cavity 107 in the face 86 of the slice 74, lying in said mid-plane 103. The manifold 102 is also produced in respect of one half in the form of an annular groove 104 made in the mating face 83 of the slice 73 and in respect of the other half in the form of an annular groove 105 made in the mating face 84 of the slice 94.

Pairs of branch ducts, here eight in number, are provided between the intermediate manifold 2 and the input 96 and output 97 manifolds, in mid-half-planes defined by the axis 4 and angularly equidistributed about the latter, each of these pairs comprising a straight duct 108, of axis 109 parallel to the axis 4, mutually joining the input manifold 96 and the intermediate manifold 102, running alongside the inner peripheral face 87 of the die 3, and a straight duct 110, of longitudinal axis 111 but having an obliquity such that this duct 110 runs alongside the outer peripheral face 88 of the cavity 107, mutually joining the intermediate manifold 102 and the outlet manifold 96. Each of the ducts 108 and 110, of the same circular cross section, has a diameter smaller than that of the manifolds 96, 97 and 102.

On applying the present invention, each of the ducts 108 and 110 is formed from the alignment, along the respective axis 109, 110, of a passage 112, 113 made along the respective axis 109, 111 in the slice 71 and opening, on one side via the groove 100 or 101 and on the other side into the mating face 79, of a respective passage 114, 115, made along the respective axis 109, 111 in the slice 72 and passing right through the latter, that is to say from its face 80 to its face 81, and of a respective passage 115, 116 made along the respective axis 109, 111 in the slice 73 and opening on one side into the face 82 of the slice 73 and on the other side into the groove 104 defining one half of the intermediate manifold 102.

Furthermore, two straight passages 117, 118 of respective axis 119, 120 parallel to the axis 4, for the injection and the return of the heat-transfer fluid respectively, are made in the slice 70, the passage 117 opening on one side into the groove 98 defining one half of the inlet manifold 96 and on the other side into the mating face 76, whereas the passage 118 emerges on one side into the groove 99 defining one half of the outlet manifold 87 and on the other side into this same face 76. The slice 69 is pierced along the same axis 119, 120, right through, that is to say between its faces 75 and 85, by a respective straight passage 121, 122 that has the same circular cross section as the corresponding passage 117, 118 respectively, the diameters of the various passages 117, 118, 121, 122 being identical to and intermediate between the respective diameters of the manifolds 96, 97, 102, on the one hand, and of the branch ducts 108, 110, on the other.

A person skilled in the art will readily understand that the various slices 69 to 74 may be produced, like the slices 35 to 40 of the punch 2, by casting or by machining from a preexisting block of a thermally conductive material, for example chosen from the range indicated above, the slices 69 to 74 also being able to be mutually assembled by one or other of the aforementioned means, namely preferably by brazing so as to directly seal the circuit 14 for circulation of the heat-transfer fluid. Likewise, each of the slices 71 to 74 that together define the cavity 107 may have, right from its manufacture, around the blind hole 95 or around the corresponding passage 92, 93, 94 respectively, a useful face having the definitive geometry of a corresponding portion of the end wall 91 or of the inner peripheral face 88 of the cavity 107 respectively, but provision may also be made for each of the slices 71 to 74 during its manufacture to be only a blank for such a useful face, and for the faces 91 and 88 to be machined only after the slices have been assembled.

It will be clearly understood that the hot-drawing punch 2 and die 3 that have just been described cooperate in the manner known from the prior art with a plane blank cut from a suitable metal sheet and then heated, in order to form the object 1, and then to cool the latter for the purpose of hardening it, so that the method of using the punch 2 and the die 3 will not be described.

Likewise, the conformation of each of the circuits 13, 14 for circulation of a heat-transfer fluid, inside the punch 2 and the die 3 respectively, will not be described further, for example in terms of the cross section of these circuits 13 and 14 depending on their regions, the most appropriate choices being able to be made by a person skilled in the art, and independently of any limitation similar to that which was cited in the prior art by the casting processes used, and whether each of the characteristic slices for implementing the present invention are produced by casting, or by machining a preexisting block of an appropriate material.

Likewise, the conformation of the cooling circuits 13 and 14 most appropriate to each geometry of the object 1 to be produced and to the geometry that the useful faces of the punch and of the die have for this purpose will, in each case, fall within the normal competence of a person skilled in the art.

In this regard, FIGS. 3 to 5, to which the reader may now refer, illustrate a punch and a die which, both being suitable for the production, for example by hot drawing, of an object having a completely different conformation to that of the object 1 that has just been described, the punch, the die and the heat-transfer fluid circuits that they contain themselves having for this purpose very different conformations, are subdivided into slices mutually assembled so as to be bonded together, this being characteristic of the present invention.

FIGS. 3 to 5 thus illustrate a punch 124 and a die 125 that are intended to cooperate in order to form, by hot drawing from an initially flat blank cut from a metal sheet, an object 126 in the form of a beam elongate along a longitudinal direction 127, which will serve as reference for the description of this object 126 like for the description of the punch 124 and the die 125. More precisely, the object 126 has in this example a double curvature, namely a curvature in a first plane of symmetry 128 which is longitudinal, and, acrosswise, a curvature in transverse planes and, in particular, in a transverse plane of symmetry 129. The object 126 is thus bounded by an outer face 130 of doubly convex curvature, by an inner face 131 of doubly concave curvature, and by a peripheral edge 132 mutually joining these two faces 130 and 131, which are approximately homothetic except for certain localized thickness variations that may result from applying the drawing operation to a blank for initially uniform thickness.

Like the longitudinal direction 127, the mid-planes of symmetry 128 and 129 will serve as reference for the following description of the punch 124 and the die 125, these planes of which also constitute a longitudinal mid-plane of symmetry and a transverse mid-plane of symmetry, respectively.

As designed and then produced, the punch 124 and the die 125 have an external outline that includes in particular a respective face for forming the object 126, namely a face 133 for forming the inner face 131 and a face 134 for forming the outer face 130 respectively, which faces 133 and 134 have a shape complementary to that of the face 131 and a shape complementary to the face 130 respectively.

Around the respective forming face 133, 134, the punch 124 and the die 125 are bounded on the outside by a ledge 135, 136 entirely bordering this forming face 133, 134 in the direction of going away from the planes 128 and 129, each of these ledges 135, 136 being defined by generatrices perpendicular to the plane 128, starting from its join to the respective forming face 133, 134.

In the direction of going away from the planes 128 and 129, the ledges 135 and 136 are joined to a respective outer peripheral face 137, 138, which is placed set back relative to the respectively corresponding ledge and to the respectively corresponding forming face, and is defined by generatrices parallel to the two planes 128 and 129.

On the opposite side from where they join the respective ledge 135, 136, the outer peripheral faces 137, 138 are joined to a plane back 139, 140 perpendicular to the two planes 128 and 129 and facing away from the respective forming face 133, 134 and from the respective ledge 135, 136. In the case of the die 125, the outer peripheral face 138 is joined directly to the back 140, whereas in the case of the punch 124, the outer peripheral face 137 is joined to the back 139 via a peripheral rim 141.

It may be seen that only the shape of the forming faces 133 and 134 and, in part, the shape of the ledges 135, 136 which border them respectively, has any importance in the forming of the object 126 by hot drawing, so that the outline of the punch 124 and of the die 125 is also of no consequence in this regard.

As designed, the punch 124 and the die 125 include, on the inside, a respective circuit 142, 143 for the circulation of a heat-transfer fluid, such as cooling water for the purpose of hardening the hot-drawn object 126, and this respective circuit 142, 143 is designed according to the cooling requirements of the object 126, at its faces 131 and 130 respectively, it being possible for these requirements to vary depending on the regions of the object 126.

In the example illustrated, each of the circuits 142, 143 thus includes two manifolds of respective longitudinal general orientation that are placed largely set back into the thickness of the punch 124 and of the die 125 respectively, relative to the respective ledge 135, 136. Thus, the circuit 142 in the punch 124 has two approximately longitudinal manifolds 144, 145 parallel to the plane 128 and mutually symmetrical with respect to the latter, one of which serves as inlet manifold for the heat-transfer fluid and the other as return manifold for this heat-transfer fluid, and the circuit 143 has two approximately longitudinal manifolds 146, 147, again parallel to the plane 128 and mutually symmetrical with respect to the latter, one of which serves as inlet manifold and the other as return manifold for the heat-transfer fluid.

More precisely, each of the manifolds 144 and 145 is subdivided longitudinally, in the example illustrated, into five elementary manifolds, which are mutually isolated from circulation of fluid from one to the other, namely two respective longitudinally extreme elementary manifolds, which are furthest away from the plane 129, a respective longitudinally central elementary manifold, which straddles the plane 129, and two respective longitudinally intermediate elementary manifolds, each of which connects a longitudinally central elementary manifold to a respective longitudinally extreme manifold. This subdivision takes account of specific cooling requirements for the object 126 and might not exist, or exist in a different form, in the case of differently shaped objects 126.

For the injection of heat-transfer fluid into each of the elementary manifolds that constitute it, the inlet manifold 144 has, as a branch, at each of the elementary manifolds that constitute it, a heat-transfer fluid inlet duct 148, which duct 148 joins this elementary manifold to the back 139 of the punch 124, parallel to the two planes 128 and 129. Likewise, each elementary manifold constituting the return manifold 145 has, as a branch, a duct 149 that joins it to the back 139 of the punch 124, parallel to the two planes 128 and 129.

Furthermore, two elementary manifolds, which are in correspondence by mutual symmetry relative to the plane 128, are joined mutually by at least one and preferably several branch ducts 150, each of which has a transverse mid-plane 154, that is to say a plane perpendicular to the direction 127 and parallel to the plane 129, and symmetrically straddles the plane 128, running alongside as close as possible to the ledge 135 and the forming face 133. Thus, illustrated here by way of non-limiting example are two ducts 150 joining two longitudinally extreme elementary manifolds, forming part of the inlet manifold 144 and of the return manifold 145 respectively, four ducts 150 mutually joining the two longitudinally central elementary manifolds, and four ducts 150 mutually joining two longitudinally intermediate elementary manifolds, forming part of the inlet manifold 144 and of the return manifold 145 respectively, the ducts 150 being mutually symmetrical relative to the plane 129, like the object 126.

In the case of the die 125, each of the manifolds 146, or heat-transfer fluid inlet manifold, and 147, or heat-transfer fluid return manifold, is longitudinally subdivided into three elementary manifolds isolated from one another with respect to circulation of the heat-transfer fluid, namely two longitudinally extreme elementary manifolds, mutually symmetrical relative to the plane 129, and a longitudinally central or intermediate elementary manifold, symmetrically straddling the plane 129. Each of these elementary manifolds has, as a branch, a duct that joins it to the back 140 of the die 125 parallel to the two planes 128 and 129, namely a heat-transfer fluid inlet duct 151 for each respective elementary manifold constituting the inlet manifold 146, and a heat-transfer fluid return duct 152 for each of the elementary manifolds constituting the return manifold 147.

Furthermore, two elementary manifolds, which correspond by mutual symmetry relative to the plane 128, are mutually joined by at least one branch duct 153 that symmetrically straddles the plane 128, running alongside and as close as possible to the ledge 136 and the forming face 134; in the non-limiting example illustrated, four of these branch ducts 153 mutually connect the longitudinally extreme elementary manifolds, which are in correspondence by mutual symmetry relative to the plane 128, and seven of these branch ducts 153 mutually join the two longitudinally central or intermediate elementary manifolds, each of these branch ducts 153 lying in a respective mid-plane 155 transverse, that is to say perpendicular, to the direction 127.

Having thus designed the circuits 142 and 143, the projected punch 124 and the projected die 125 are divided into a plurality of slices 156, 157, each of which is bounded in particular by at least one face and, acrosswise, by two mating faces 160, 161 for mating with an immediately adjacent slice, which mating faces 160, 161 coincide with the mid-plane 154, 155 of a respective branch duct 150, 153. Each of the slices 156 of the punch 124 is also bounded by a corresponding section of the forming face 133, of the ledge 135, of the outer peripheral face 137 and of the back 139, and likewise each slice 157 of the die 125 is also bounded by respective sections of the forming face 134, of the ledge 136, of the outer peripheral face 138 and of the back 140. With the exception of the longitudinally extreme slices 156, 157, which have only a single mating face, these respective sections are bounded by their join to two respective mating faces, defining the same slice 156 or 157.

According to the present invention, each slice 156, 157 is produced independently of the other slices, for example by casting or by machining in a preexisting block of a thermally conductive material chosen, for example, from the aforementioned materials, in a manner that has been illustrated in FIG. 4 in respect of a longitudinally intermediate slice 138 of the die 125 and can be transposed without difficulty to each of the longitudinally intermediate slices 156 of the punch 124, so as to have:
in each mating face 160, which coincides at least approximately with a mid-plane 155, a respective groove 162 at least approximately corresponding to one half of a branch duct 153, as subdivided by its mid-plane 155; and
in the thickness of the slice 157, two manifold passages or sections 158, 159 that pass right through the slice 157, that is to say from one of its mating faces 160 to the other, which collector sections are joined to each of the grooves 162 and which constitute a section of an elementary manifold of the inlet manifold 146 and a section of an elementary manifold of the return manifold 147, respectively.

In the case of the longitudinally extreme slices 157, which have a single mating face 160, and consequently a single groove 162, the manifold sections 158 and 159 are blind, that is to say they open exclusively into this mating face 160.

It will be observed in FIG. 4 that the implementation of the present invention makes it possible for a section changing in any desired manner, for example by milling in the corresponding mating face 160, to communicate easily with each groove 162, that is to say with each branch duct 153, the groove 162 thus having a localized widening 163 around the longitudinal mid-plane of symmetry 128. It will also be observed in FIG. 3, referring to the longitudinally extreme elementary manifolds and more precisely to their ends closest to the longitudinally central or intermediate elementary manifolds, that each manifold section 158 and 159 cannot only be straight and produced, for example, by drilling, from one of the mating faces 160 or the other, but also may have a V shape, defined by two straight arms mutually offset angularly and produced, for example, by drilling from each of the mating faces 160.

Depending on their position, the heat-transfer fluid inlet duct 151 and the heat-transfer fluid return duct 152 may be provided in the thickness of a corresponding slice 157, in order to run into the section 158 or manifold section 159, respectively; although they lie at least approximately in a mid-plane 155 corresponding to a branch duct 153, they may also be made, like this branch duct, in halves in two mating faces 160 belonging to mutually adjacent slices 157.

Upon mutual assembly of the slices 157, mutually applied, flat, via their mating faces 160, the grooves 162 are complementary from one slice 157 to the other in order to form the branch ducts 153, and likewise the sections 158 and 159, respectively, are complementary from one slice 157 to the other, in order to form the elementary manifolds of the inlet manifold 146 and of the return manifold 147 and, where appropriate, the same applies to the constituent halves of each duct 151 or 152, thereby constituting the circuit 143. Sealing around the latter, and likewise integral assembly of the slices 157, may be obtained by any appropriate means, mutual brazing of the slices 157 being preferred in this regard if their constituent material lends itself thereto, insofar as such brazing makes it possible to achieve both mutual bonding and sealing of the circuit 143.

Similarly, as a person skilled in the art will readily deduce from what has just been described in regard to the die 125, with reference to FIGS. 3 and 4, the circuit 142 in the punch 124 is formed, upon mutual assembly of the slices 156, on the one hand by grooves which, provided in their mating faces 161 at least approximately coinciding with the mid-planes 154, are complementary so as to constitute the branch ducts 150 and, where appropriate, the ducts 148 and 149 that can also be made in the thickness of the slices 156, and, on the other hand, by passages constituting manifold sections 144, 145 that are provided through the slices 156, except as regards the longitudinally extreme slices in which these sections are blind, and are complementary in order to constitute the constituent elementary manifolds of the manifolds 144 and 145, respectively.

When, as has been described, each manifold 144, 145, 146, 147 is formed from several mutually independent elementary manifolds as regards the circulation of the heat-transfer fluid, those of the slices 156 and 157 that correspond to the transition between two elementary manifolds may be deprived of any through-passage or through-section such as 158 and 159 or may be provided with such sections in blind form so as to avoid any fluid communication between the various constituent elementary manifolds of one and the same manifold, as a person skilled in the art will readily understand.

As a person skilled in the art will also readily understand, the forming faces 133 and 134 may, again in the case of the punch 124 and of the die 125, be machined, after the various slices 156, 157 have been assembled, from a forming face blank consisting of useful face blanks for each slice 156, 157; each slice 156, 157 may also have, right from its manufacture, a useful face having the definitive shape of a forming face section 133, 134, in which case the forming faces 133, 134 are formed by these useful faces, directly upon assembling the slices 156, 157. The same applies as regards the ledges 135 and 136.

Such a person skilled in the art will readily understand that, although the subdivision of a tool such as a punch 2 or 124 or a die such as 3 or 125 into slices bounded between them by mutually parallel mating faces is preferred, and can correspond in most cases to a generally satisfactory conformation of the circuit 13, 14, 143, 144, that is to say for most shapes of objects 1 or 126 to be produced by hot drawing or, not shown but readily understandable by a person skilled in the art, by injection molding of a thermoplastic, other methods of subdivision, imposed by a more appropriate conformation of the heat-transfer fluid circuit, could be chosen without thereby departing from the scope of the present invention, it being possible for these methods of subdivision to result in the mating faces between slices, which at least approximately coincide with average surfaces of certain constituent ducts of the heat-transfer fluid circuit, being not parallel to one another, or even having a shape different from a plane shape.

A person skilled in the art will also have no difficulty in transposing the provisions that have been described with reference to hot-drawing tools to the production of thermoforming tools, without any fundamental difference as regards the design of these tools, the cooling fluid being simply replaced with a heating fluid, or the production of tools for the injection molding of thermoplastics in a molding impression, the essential difference consisting in the fact that the mold portions that correspond respectively to the punch and to the die that have just been described must, in a closed position of the mold, be mutually contiguous around an impression that they define by their faces corresponding to the forming faces described, whereas such is not necessarily the case when dealing with a punch and a die at the end of the relative movement in hot drawing.

In general, the subject of the present application is susceptible to many variants, tailored to each shape of object to be produced and to the way in which the tools work in order to form this object, without thereby departing from the scope of this invention as defined by the appended claims.

1. A method of producing a tool intended for the forming of a material by hot drawing or injection molding, for the purpose of making an object of defined shape therefrom, said tool having a forming face of shape complementary to at least one portion of said defined shape, said method including designing a contour of the tool to be produced, which has a projected forming face having said complementary shape, and devising, on the inside of said projected contour, according to said complementary shape, a projected circuit for the circulation of a heat-transfer fluid inside the tool to be produced, said projected circuit having a plurality of projected ducts at least one of which constitutes a projected manifold and at least one other of which constitutes a projected branch off the projected manifold and running alongside the projected forming face,
characterized:
in that the initial step a) is implemented by placing at least a projected first duct over as simple as possible an average surface, the average surface of the or each projected first duct intersecting the projected forming face, thereby defining sections of the projected forming face, and of at least one projected second duct, thereby defining sections of the or each projected second duct; and
in that the method then comprises the succession of steps consisting in;
b: producing tool slices, each of which is bounded in particular by at least one mating face, at least certain mating faces at least approximately reproducing a respective average surface, namely, acrosswise, by two mating faces at least approximately reproducing, respectively, each of the two respective average surfaces, and by at least one blank for a useful face reproducing a respective projected forming face section adjacent said respective average surface, namely, in a spanning manner, a projected forming face section bounded by said respective two average surfaces, and includes, on the one hand, within its thickness, a passage reproducing the respective section of the or each projected second duct and emerging in the or each mating face and, on the other hand, in the or each mating face a groove connected as a branch off said passage and at least approximately reproducing one half of the respective projected first duct,
c: juxtaposing the tool slices via their mating faces and mutually fastening them in a relative position in which the useful faces or said blanks, the passages and the grooves are complementary from one slice to the other slice in order to constitute, respectively, the forming face or a forming face blank, the or each second duct and the or each first duct, and, where appropriate, machining the forming face blank in order to produce the forming face.

2. The method as claimed in claim 1, wherein said initial step is implemented by giving the or each average surface and the or each mating face an at least approximately plane shape.

3. The method as claimed in claim 2, wherein, in the case of a plurality of said average surfaces and of said mating, faces, said initial step a) is implemented by orienting said average surfaces and said mating faces, respectively, so as to be at least approximately parallel to one another.

4. The method as claimed in claim 1, wherein said initial step is implemented by giving each projected second duct section a straight shape or a V shape defined by two angularly offset straight arms.

5. The method as claimed in claim 1, wherein, when, in the case of an object having the shape of a beam or a similar shape, elongate along a defined longitudinal direction, the initial step a) is implemented by giving the projected forming face a shape elongate along a defined longitudinal direction, the initial step a) is also implemented by orienting the or each projected manifold at least approximately longitudinally and by orienting the or each projected branch and the or each average surface at least approximately transversely and by choosing, as projected first duct, the or each projected branch and, as projected second duct, the or each manifold, and step b) is implemented by orienting the or each mating face and the or each groove at least approximately transversely and by orienting the or each passage at least approximately longitudinally.

6. The method as claimed in claim 1, wherein, when, in the case of an object having the shape of a pot or a similar shape, going around a defined longitudinal axis, the initial step a) is implemented by giving the projected forming face a shape going around a defined longitudinal axis, the initial step a) is also implemented by orienting the or each projected branch at least approximately longitudinally and orienting the or each projected manifold and the or each average surface at least approximately transversely and by choosing, as projected first duct, the or each projected manifold and, as projected second duct, the or each projected branch, and step b) is implemented by orienting the or each mating face and the or each groove at least approximately transversely and by orienting the or each passage at least approximately longitudinally.

7. The method as claimed in claim 1, wherein the tool slices are produced, during step b), by machining in a preexisting block of thermally conductive raw material.

8. The method as claimed in claim 7, wherein said raw material is chosen from a group consisting of Al₂O₃-copper alloys, cadmium copper alloys, beryllium copper alloys and stainless steels.

9. A tool intended for the forming of a material, in particular by hot drawing or injection molding, for the purpose of making an object of defined shape therefrom, said tool having for this purpose a forming face of shape complementary to at least one portion of said defined shape, and an internal circuit for the circulation of a heat-transfer fluid, said circuit comprising a plurality of ducts, at least one of which constitutes a manifold and at least one other of which constitutes a branch off the manifold and running alongside the forming face,
said tool comprising a bonded assembly of tool slices mutually juxtaposed by mating faces, at least certain of which coincide at least approximately with as simple as possible an average surface, of a first duct, and which intersect the forming face, thereby defining forming face sections, and of at least one second duct, thereby defining second duct portions.

10. The tool as claimed in claim 9, wherein the or each mating face and the or each average surface are at least approximately plane.

11. The tool as claimed in claim 10, wherein said mating faces and said average surfaces are respectively at least approximately parallel to one another.

12. The tool as claimed in claim 9, wherein each second duct has a straight shape or a V shape defined by two angularly offset straight arms.

13. The tool as claimed in claim 9, wherein, when, in the case of an object having the shape of a beam or a similar shape, elongate along a defined longitudinal direction the forming face has a shape elongate along a defined longitudinal direction, the or each mating face and the or each average surface are at least approximately transverse, the or each first duct is at least approximately transverse and constitutes a branch and the or each second duct is at least approximately longitudinal and constitutes a manifold.

14. The tool as claimed in claim 9, wherein, when, in the case of an object having the shape of a pot or a similar shape, going around a defined longitudinal axis, the forming face has a shape going around a defined longitudinal axis, the or each mating face and the or each surface are at least approximately transverse, the or each first duct is at least approximately transverse and constitutes a manifold, and the or each second duct is at least approximately longitudinal and constitutes a branch.

15. The tool as claimed in claim 9 wherein each tool slice results from machining in a block of thermally conductive raw material.

16. The tool as claimed in claim 15, wherein said raw material is chosen from a group consisting of Al₂O₃-copper alloys, cadmium copper alloys, beryllium copper alloys and stainless steels.

17. The tool as claimed in claim 9 comprising a hot-drawing tool chosen from a group consisting of punches and dies.

18. The tool as claimed in claim 9, wherein it constitutes one component of an injection-molding mold.
